(19) United States
(12) Patent Application Publication
(10) Pub. No.: US 2014/0085934 A1
(43) Pub. Date: Mar. 27, 2014

(54) BACKLIGHT MODULE AND LCD DEVICE

(71) Applicants: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(72) Inventors: Yicheng Kuo, Shenzhen (CN); Shihhsiang Chen, Shenzhen (CN); Gang Yu, Shenzhen (CN); Gege Zhou, Shenzhen (CN); Jiaqiang Wang, Shenzhen (CN)

(73) Assignee: SHENZHEN CHINA STAR OPTOELECTRONICS TECHNOLOGY CO. LTD., Shenzhen (CN)

(21) Appl. No.: 13/643,548

(22) PCT Filed: Sep. 28, 2012
(86) PCT No.: PCT/CN12/82288

§ 371 Date: Oct. 26, 2012

(30) Foreign Application Priority Data
Sep. 24, 2012 (CN) 201220487854.3

(51) Int. Cl. F21V 8/00

(52) U.S. Cl. CPC G02B 6/0011
USPC 362/615

(57) ABSTRACT

The present disclosure relates to a backlight module and a liquid crystal display (LCD) device. The backlight module includes a light guide panel (LGP), and a backplane. The backplane includes sidewalls, and a bottom wall. The LGP is arranged in the backplane. The backlight module further includes fixing pieces. The LGP is configured with a first fixing hole, and the sidewall or the bottom wall of the backplane is configured with a second fixing hole. The fixing piece penetrates through the first fixing hole in the LGP and the second fixing hole in the backplane and fixes the LGP to the backplane. In the present disclosure, the LGP is fixed to the backplane through the fixing piece penetrating through both the first fixing hole in the LGP and the second fixing hole in the backplane thereby preventing the LGP from moving upwards and downwards in the vertical direction.

### TECHNICAL FIELD

The present disclosure relates to the field of liquid crystal displays (LCDs), and MOM particularly to a backlight module, and an LCD device.

### BACKGROUND

As shown in FIG. 1, a typical liquid crystal display (LCD) device includes a front frame I. an LCD panel 2, a middle frame 3, a light guide panel LGP) 4, and a backplane 5. The LGP 4 is configured with a optical film. The front frame 1, the middle frame 3, and the backplane 5 have different functions: the front frame 1 is mainly used to fix the LCD panel 2 and prevent the LCD panel 2 from coming out; the backplane 5 is mainly used to support the optical film, the LGP 4, the lightbarand the like: and the middle franc 3 is mainly used to fix the LGP 4, the optical film and the like together with the backplane 5 and used to support the LCD panel 2. A backlight module is formed by the backplane 5, the middle frame 3, and the LGP 4, the optical film, the lightbar, and the like, which are fixed by the backplane 5 and the middle frame 3.

The typical LGP is tightly pressed in the backplane by the middle frame, and the backlight module is fixed to the LCD panel by the front frame. The backlight module as an intermediate product is transported, and the LGP is only fixed and limited by the middle frame in the transportation process of the backlight module. Because of assembly tolerance factors and part tolerance factors, sometimes the pressing force of the middle flame to the LGP is insufficient. Thus, in the transportation process of the backlight module, the LGP may be moved upwards and/or downwards and even tilted, thereby affecting the optical quality If structure of the LCD device is simplified, the middle frame is not arranged in the backlight module nor is the middle frame arranged in the backlight module not used to fix the LGP, which becomes a great problem to fix the LGP in the transportation process.

### SUMMARY

In view of the above-described problems, the aim of the present disclosure is to provide a backlight module, and a liquid crystal display (LCD) device, The light guide panel (LGP) of the backlight module is well fixed in the vertical direction, thereby ensuring that the LGP is not easily moved in the transportation process of the backlight module, and ensuring that the backlight module has higher optical quality.

A fins technical scheme of the present disclosure is that: a backlight module comprises a light guide panel (LGP) and a backplane. The backplane comprises sidewalls, and a bottom wall. The LGP is arranged in the backplane. The backlight module further comprises fixing pieces. The LGP is configured with a first fixing hole, and the sidewall or the bottom wall of the backplane is configured with a second fixing hole. The LGP is fixed to the backplane through the fixing piece penetrating through both the first fixing hole in the LGP and the second fixing hole in the backplane.

In one example, the fixing piece comprises a head end and a tail end, and the head end is connected with the tail end by a fastener structure. The fastener structure has advantages of quick connection and installation and can increase assembling efficiency.

In one example, the head end of the fixing piece is configured with a third fixing hole, the side surface of the tail end is configured with a fastener, and the fastener is inserted into the third fixing hole of the head end to connect the head end with the tail end.

In one example, a cross-section of the fixing piece is rectangular, the third fixing, hole of the fixing piece is rectangular, and a cross-section of the tail end is rectangular. Thus, the fixing piece is closely attached to the LGP and the surface of the backplane, to make fixation better.

In one example, the fixing piece is a white or colorless transparent plastic piece, to avoid generating interference to the optical performance of the LGP.

In one example, the backlight module further comprises a middle frame, and the middle frame is arranged above the LGP. The middle frame comprises a plurality of member units; gaps are set between adjacent member units, and the fixing pieces are arranged between the adjacent member units of the middle frame.

In one example, the member units are frame corner members and are distributed on four corners of the backplane or the member units are frame edge members and are distributed on the four edges of the backplane.

Advantages of the present disclosure are summarized below: by arranging the first fixing hole in the LGP and arranging the second fixing hole in the sidewall or bottom wall of the backplane, the fixing piece penetrating through both the first fixing hole and the second fixing hole and then fixes the LGP to the backplane, thereby preventing the LGP from moving upwards and/or downwards in the vertical direction, ensuring that the LGP is not moved and/or tilted even when the transportation process is rough, and then well ensuring that the backlight module has higher optical quality. Because the middle frame is not used to fix the LGP and the optical film, the middle frame may be simplified into sectioned structure and can even be removed, to simplify the structure of the LCD device.

The present disclosure further provides a second technical scheme: an LCD device comprises the backlight module mentioned above.

The present disclosure further provides a third technical scheme: an LCD device comprises an LGP, and a backplane. The backplane comprises sidewalls. The LGP is arranged in the backplane, the LGP is configured with a first fixing hole, and the sidewall or the bottom wall of the backplane is configured with a second fixing hole.

In one example, the LCD device has no middle frame.

In one example, the LCD device comprises a middle frame, and the middle frame is arranged above the LGP. The middle frame comprises a plurality of member units; gaps are set between adjacent member units, and the fixing pieces are arranged between the adjacent member units of the middle frame.

The aforementioned fixing pieces can only be used in the transportation process of the backlight module and can be removed when the LCD device is being assembled. The LGP can be pressed and fixed by other components above the LGP, such as the LCD panel. Thus, the sidewall or the bottom wall of the backlight module is reserved with the first through hole, and the LGP is reserved with the second fixing hole.

### BRIEF DESCRIPTION OF FIGURES

FIG. 1 is a structural diagram of a typical liquid crystal display (LCD) device;

FIG. 2 is a solid diagram of a first example of a backlight module of the present disclosure;

FIG. 3 is a partial sectional view of a first example of a backlight module of the present disclosure;

FIG. 4 is a structural diagram of a fixing piece of a first example of a backlight module of the present disclosure;

FIG. 5 is a solid diagram of a second example of a backlight module of the present disclosure;

FIG. 6 is a partial sectional view of a third example of a backlight module of the present disclosure; and

FIG. 7 is a partial sectional view of a fourth example of a backlight module of the present disclosure.

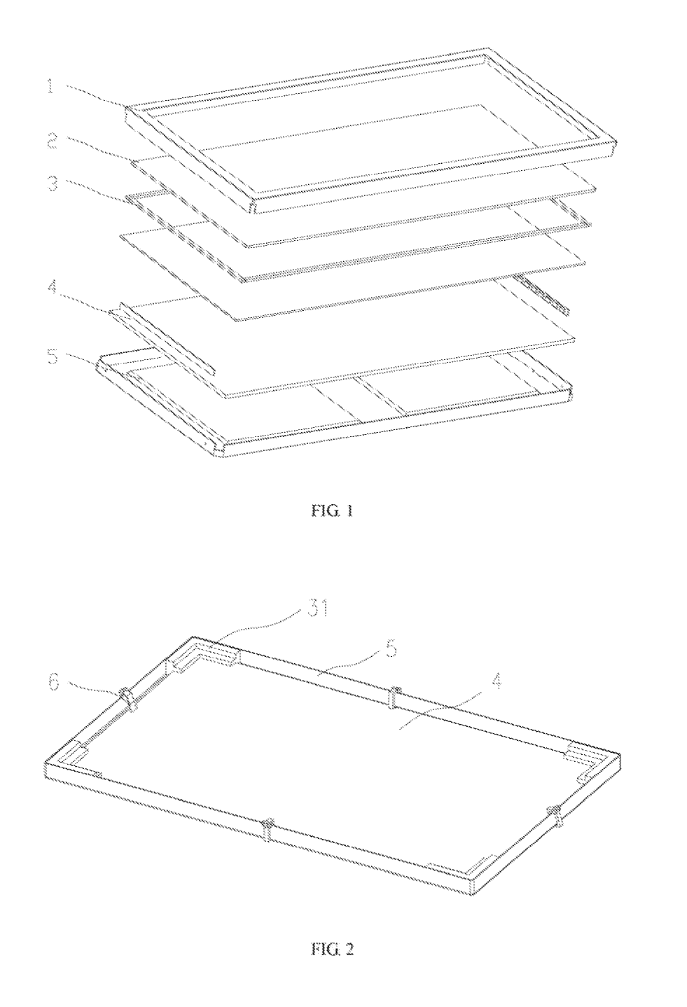

### DETAILED DESCRIPTION

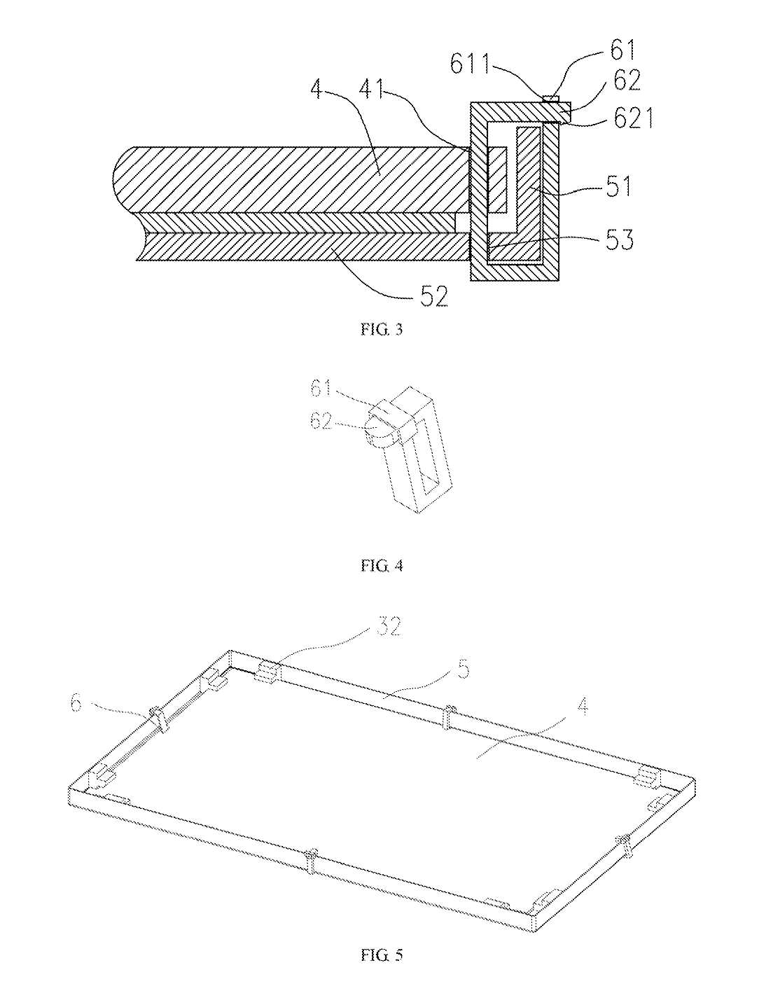

The present disclosure provides a liquid crystal display (LCD) device, comprising a backlight module. FIG. 2-FIG. 4 show a first example of the backlight module of the present disclosure. The backlight module comprises a light guide panel (LGP) 4 and a backplane 5. The backplane 5 comprises sidewalls 51 and a bottom wall 52. The LGP 4 is arranged in the backplane 5. The backlight module further comprises fixing pieces 6. The LGP 4 is configured with a first fixing hole 41, and the bottom wall 52 of the backplane is configured with a second fixing hole 53. The LGP 4 is fixed to the backplane 5 through the fixing piece 6 penetrating through both the first fixing hole 41 in the LGP 4 and the second fixing hole 53 in the backplane 5.

In the present disclosure, through the LGP is configured with the first fixing hole 41, and the sidewalk or the bottom wall of the backplane is configured with the second fixing bole 53 the LGP 4 is fixed to the backplane 5 through the fixing piece 6 penetrating through both the first fixing hole 41 in the LGP 4 and the second fixing hole 53 in the backplane 5, thereby preventing the LGP 4 from moving upwards and/or downwards in the vertical direction, and the LGP 4 is not moved and/or tilted even when transportation process is rough, and the backlight module has higher optical quality.

In the example, number of the fixing pieces 6 is four, and the fixing pieces 6 are distributed in the middle of the four sidewalls of the backplane 5. Thus, the LGP 4 may obtain a uniform fixing force. The number and position of the fixing pieces 6 may be freely set in accordance with actual demand.

In the example, the backlight module further comprises a middle frame 3, and the middle frame 3 is arranged above the LGP 4. The middle frame 3 comprises to plurality of member units; gaps are set between all the adjacent member units, and the fixing pieces 6 are arranged between the adjacent member units of the middle frame. Specifically, the member units are frame corner members 31 and are distributed about the four corners of the backplane 5. Because the middle frame 3 is a sectioned structure, and gaps are set, between all the adjacent frame corner members 31, there is risk of insufficient fixing force of the LGP 4. The fixing pieces 6 arranged on the backplane 5 fix the LGP 4, to prevent the LGP 4 from moving upwards and downwards in the vertical direction. The LGP 4 is prevented from moving and tilting even in the severely required transportation process, thereby the backlight module has higher optical quality.

When the backlight module is not configured with the middle frame or configured with the middle frame not fixed to the LGP, problems such as insufficient pressing force of the LGP, even no pressing force, upwards and downwards movement, and even tilt of the LGP in the transportation and use process, which are mentioned in the background, may be easy to occur. Because the fixing pieces are used to prevent the LGP from moving upwards and downwards in the vertical direction in the present disclosure, even the backlight module is not configured with the middle frame or is configured with the middle frame not fixed the LGP, the technical problem is still solved.

In the example, the fixing piece 6 comprises a head end 61 and a tail end 62. The head end 61 is connected with the tail end 62 by fastener structure. Specifically, the head end 61 is configured with a third fixing hole 611, the side suffice of the tail end 62 is configured with a fastener 621, and the fastener 621 is inserted into the third fixing hole 611 of the head end to connect the head end 61 with the tail end 62, The fastener structure has advantages of quick connection and installation, and can increase assembly efficiency.

In one example, a cross-section of the fixing piece 6 is rectangular, the third fixing hole 611 of the fixing piece 6 is rectangular, and the cross-section of the tail end 62 is rectangular. Thus, the fixing piece 6 is closely attached to the LGP 4 and the surface of the backplane 5, to make fixation better.

In one example, the fixing piece 6 is a white or colorless transparent plastic piece, to avoid generating interference to optical performance of the LGP 4.

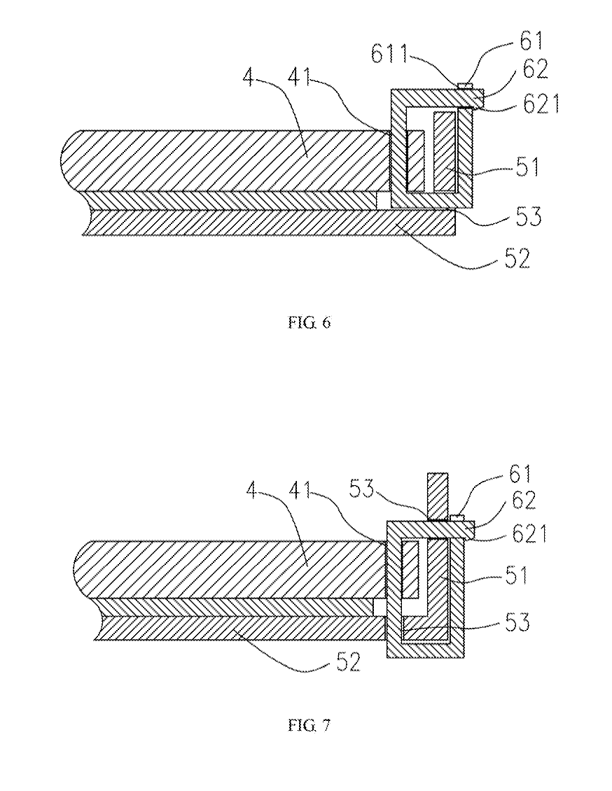

FIG. 5 shows a second example of the backlight module of the present disclosure, and the second example is different from the first example in that: the member units are frame edge members 32 and are distributed about the our edges of the backplane; gaps are set between all the adjacent frame edge members 32. Other structures and advantages of the example are consistant with the first example, and the example will not give detailed. description.

Optionally, in all the above examples, the middle frame can be formed by the frame corner members and the frame edge members together. The frame corner members are distributed on the four corners of the backplane, the frame edge members are distributed on the four edges of the backplane, and the fixing, pieces are distributed between adjacent member units, to fix the LGP.

FIG. 6 shows a third example of the backlight module of the present disclosure, and the third example is different from the first example in that: the sidewall 51 of the backplane is configured with a second fixing hole 53, The LGP 4 is fixed to the backplane 5 through the fixing piece 6 penetrating through both the first fixing hole 41 in the LGP 4 and the second fixing bole 53 in the backplane 5. The structure may be adopted when the bottom of the backplane is not suitable for arranging holes. Other structures and advantages of the example are consistant with the first example, and the example will not give detail description.

FIG. 7 shows a fourth example of the backlight module of the present disclosure, and the fourth example is different from the first example in that: the sidewall 51 and the bottom wall 52 of the backplane are both configured with second fixing holes 53, The LGP 4 is fixed to the backplane 5 through the fixing piece 6 penetrating through both the first fixing hole 41 in the LGP 4 and the second fixing hole 53 in the backplane 5. When the sidewall 51 of the backplane is 141, and the fixing pieces surround the sidewalls 51 of the entire backplane, there may be a certain moving space for the LGP in the vertical direction. By arranging the second fixing hole 53 in the middle of the sidewall 51 of the backplane, the fixing piece may better fix the LGP. When the height of the second fixing hole 53 is close to height of the LGP, fixing effect is better. Other structures and advantages of the example are consistant with the first example, and the example will not give detail description.

As another example of the LCD device, the backlight module comprises an LGP 4, and a backplane 5. The backplane 5 comprises sidewalls 51, and a bottom wall 52. The LGP 4 is arranged in the backplane 5. The LGP 4 is configured with a first fixing hole 41, and the sidewall or the bottom wall of the backplane is configured with a second fixing hole 53. The aforementioned fixing pieces 6 can only be used in the transportation process of the backlight module and can be removed when the LCD device is being assembled. The LGP 4 can be pressed and fixed by other components above the LGP 4, such as the LCD panel. Thus, the sidewall or the bottom wall of the backlight module is reserved with the second fixing hole 53, and the LGP 4 is reserved with the first fixing hole 41.

In the example, whether the LCD device uses no middle frame or uses sectioned middle frame, namely the middle frame comprises a plurality of member units, gaps are set between all the adjacent member units, and the fixing pieces are arranged between the adjacent member units of the middle frame, the LGP may not move in the transportation process, thereby the backlight module has higher optical quality.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements.

1. A backlight module, comprising:
a light guide panel (LGP);
a backplane comprising sidewalls and a bottom wall; and
a fixing piece;
wherein the LGP is arranged in the backplane: the LGP is configured with a first fixing hole, and the sidewalls or the bottom wall of the backplane is configured with a second fixing hole; the LGP is fixed to the backplane through the fixing piece penetrating through both the first fixing hole in the LGP and the second fixing hole in the backplane.

2. The backlight module of claim 1, wherein the fixing piece comprises a head end and a tail end, wherein the head end is connected with the tail end by a fastener structure.

3. The backlight module of claim 2, wherein the head end of the fixing piece is configured with a third fixing hole, a side surface of the tail end is configured with a fastener, and the fastener is inserted into the third fixing hole of the head end to connect the head end with the tail end.

4. The backlight module of claim 3, wherein a cross-section of the fixing piece is rectangular, the third fixing hole of the fixing piece is rectangular, and a cross-section of the tail end is rectangular.

5. The backlight module of claim 1, wherein the fixing piece is a white or colorless transparent plastic piece.

6. The backlight module of claim 1, wherein the backlight module further comprises a middle frame, and the middle frame is arranged above the light guide panel (LGP); the middle frame comprises a plurality of member units; gaps are set between all the adjacent member units, and the fixing pieces are arranged between the adjacent member units of the middle frame.

7. The backlight module of claim 6, wherein the member units are frame corner members and distributed on four corners of the backplane, or the member units are frame edge members and are distributed on four edges of the backplane.

8. A liquid crystal display (LCD) device, comprising:
a backlight module comprising a light guide panel (LGP), a backplane, and a fixing piece;
wherein the backplane comprises sidewalls and a bottom wall; the LGP is arranged in the backplane; the LGP is configured with a first fixing hole, and the sidewalls or the bottom wall of the backplane is configured with a second fixing hole; the LGP is fixed to the backplane through the fixing piece penetrating through both the first fixing hole in the LGP and the second fixing hole in the backplane.

9. The liquid crystal display (LCD) device of claim 8, wherein the fixing piece comprises a head end and a tail end, and the head end is connected with the tail end by a fastener structure.

10. The liquid crystal display (LCD) device of claim 9, wherein the head end of the fixing piece is configured with a third fixing hole, a side surface of the tail end is configured with a fastener, and the fastener is inserted into the third fixing hole of the head end to connect the head end with the tail end.

11. The liquid crystal display (LCD) device of claim 10, wherein a cross-section of the fixing piece is rectangular, the third fixing hole of the fixing piece is rectangular, and a cross-section of the tail end is rectangular.

12. The liquid crystal display (LCD) device of claim 8, wherein the fixing piece is a white or colorless transparent plastic piece.

13. The liquid crystal display (LCD) device of claim 8, wherein the backlight module further comprises a middle frame, and the middle frame is arranged above the light guide panel (LGP); the middle frame comprises a plurality of member units; gaps are set between the adjacent member units, and the fixing pieces are arranged between the adjacent member units of the middle frame,

14. The liquid crystal display (LCD) device of claim 13, wherein the member units are frame corner members and are distributed about four corners of the backplane, or the member units are frame edge members and are distributed about four edges of the backplane.

15. A liquid crystal display (LCD) device, comprising:
a backplane; and
a light guide panel (LGP) comprising sidewalls; the LGP is configured with a first fixing hole, and the sidewall or a bottom wall of the backplane is configured with a second fixing hole.

16. The liquid crystal display (LCD) device of claim 15, wherein the LCD device has no middle frame or the LCD device comprises a middle frame; the middle frame is arranged above the LGP, and the middle frame comprises a plurality of member units; gaps are arranged between the adjacent member units, and the fixing pieces are arranged between the adjacent member units of the middle frame.

17. The liquid crystal display (LCD) device of claim 15, wherein the LCD device comprises a middle frame; the middle frame is arranged above the LGP, and the middle frame comprises a plurality of member units, gaps are arranged between the adjacent member units, and the fixing pieces are arranged between the adjacent member units of the middle frame.
